(19) United States
(12) Patent Application Publication
(10) Pub. No.: US 2018/0277846 A1
(43) Pub. Date: Sep. 27, 2018

(54) CATHODE MATERIAL FOR LITHIUM-ION SECONDARY BATTERY AND MANUFACTURING METHOD THEREOF, CATHODE FOR LITHIUM-ION SECONDARY BATTERY, AND LITHIUM-ION SECONDARY BATTERY

(71) Applicant: SUMITOMO OSAKA CEMENT CO., LTD., Tokyo (JP)

(72) Inventors: Kouji OONO, Tokyo (JP); Hirofumi Yasumiishi, Tokyo (JP); Masataka OYAMA, Tokyo (JP); Takao KITAGAWA, Tokyo (JP)

(21) Appl. No.: 15/710,581

(22) Filed: Sep. 20, 2017

(30) Foreign Application Priority Data
Mar. 23, 2017 (JP) 2017-056987

(51) Int. Cl. H01M 4/58; H01M 4/525; H01M 4/505; H01M 10/0525

(52) U.S. Cl. CPC H01M 4/5825; H01M 4/525; C01B 25/081; H01M 10/0525; H01M 4/505

(57) ABSTRACT

A cathode material for a lithium-ion secondary battery of the present invention includes active material secondary particles formed by aggregating central particles including primary particles of a cathode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5) and a carbonaceous film, wherein at least a portion of surfaces of the primary particles are coated with the carbonaceous film, and the carbonaceous film is obtained by thermal decomposition of an organic compound, in which, in a charge and discharge cycle test at 60° C. of the lithium-ion secondary battery including a cathode including the active material secondary particles and an anode made of graphite, an amount of the element represented by A penetrates into or is precipitated on the anode after 500 cycles, is 600 ppm or less of a mass of the active material secondary particles.

### CROSS-REFERENCE TO RELATED APPLICATIONS

This application claims the benefit of Japanese Patent Application No. 2017-056987 filed Mar. 23, 2017, the disclosure of which is herein incorporated by reference in its entirety.

### BACKGROUND OF THE INVENTION

### Field of the Invention

The present invention relates to a cathode material for a lithium-ion secondary battery and a manufacturing method thereof, a cathode for a lithium-ion secondary battery, and a lithium-ion secondary battery.

### Description of Related Art

In recent years, as small-sized, lightweight, and high-capacity batteries, non-aqueous electrolytic solution-based secondary batteries such as lithium-ion secondary batteries have been proposed and put into practical use. Lithium-ion secondary batteries are constituted of a cathode and an anode which have properties capable of reversibly intercalating and deintercalating lithium ions, and a non-aqueous electrolyte.

Lithium-ion secondary batteries have a smaller size and a higher energy and weigh less than secondary batteries in the related art such as lead batteries, nickel cadmium batteries, and nickel metal hydride batteries. Therefore, lithium-ion secondary batteries are used as small-size power supplies that are used in portable electronic devices such as mobile phones and notebook personal computers. In addition, in recent years, studies have been underway to use lithium-ion secondary batteries as high-output power supplies such as electric vehicles, hybrid vehicles, and electric tools.

Electrode active materials for lithium-ion secondary batteries that are used as high-output power supplies are required to have high-speed charging and discharging characteristics. In addition, regarding lithium-ion secondary batteries, studies are also underway to flatten power generation loads or apply the batteries as large-size batteries such as stationary power supplies and backup power supplies, and the amount of resources causing no problems is also emphasized together with long-term stability and reliability.

Cathodes in lithium-ion secondary batteries are constituted of electrode material paste including a Li-containing metal oxide having properties capable of reversibly intercalating and deintercalating lithium ions, which is called a cathode active material, a conductive auxiliary agent, and a binder resin. Cathodes in lithium-ion secondary batteries are formed by applying this electrode material paste to the surface of a metal foil that is called an electrode current collector. As cathode active materials for lithium-ion secondary batteries, generally, lithium cobaltate (LiCoO₂) is used. Additionally, as cathode active materials for lithium-ion secondary batteries, lithium (Li) compounds such as lithium nickelate (LiNiO₂), lithium manganate (LiMn₂O₄), and lithium iron phosphate (LiFePO₄) are used. Among these, lithium cobaltate or lithium nickelate has a problem with the toxicity of elements or the amount of resources and a problem with the instability of charging states or the like. In addition, lithium manganate is pointed out to have a problem with the dissolution in electrolytic solutions at high temperatures. Therefore, phosphate-based electrode active materials having an olivine structure, which are represented by lithium iron phosphate having excellent long-term stability and excellent reliability are attracting attention (for example, refer to Japanese Laid-open Patent Publication No. 2001-015111).

### SUMMARY OF THE INVENTION

Phosphate-based electrode active materials have insufficient electron conductivity. Therefore, in order to carryout the charging and discharging of a large amount of current in lithium-ion secondary batteries having electrodes including phosphate-based electrode active materials, a variety of efforts such as the miniaturization of phosphate-based electrode active material particles and conjugation between phosphate-based electrode active materials and conductive substances are required. Thus far, a number of attempts have been made regarding the above-described efforts.

However, conjugation using a large amount of a conductive substance causes a decrease in electrode densities, and thus a decrease in the densities of batteries, that is, a decrease in the capacities per unit volume is caused. Examples of a method for solving the above-described problem include a carbonaceous film method in which a solution including an organic compound as a carbon precursor that is a conductive substance is used. Examples of the carbonaceous film method include a method in which a solution including an organic compound and electrode active material particles are mixed together, the mixture is dried, and then, the dried substance is thermally treated in a non-oxidative atmosphere, thereby carbonizing the organic compound. According to this method, it is possible to extremely efficiently coat the surfaces of electrode active material particles with a minimum necessary amount of a conductive substance. As a result, it is possible to improve the conductivity of electrode materials including electrode active material particles and conductive substances without significantly decreasing electrode densities.

Meanwhile, in lithium-ion secondary batteries, carbon-based materials are generally used as anode materials. Carbon-based materials generate coated films that are called solid-electrolyte interphase (SEI) films through the reductive decomposition of electrolytic solutions in the interface with the electrolytic solutions. Therefore, it is possible to realize the stable intercalation and deintercalation of lithium ions and suppress the excessive decomposition of electrolytic solutions, and favorable cycle performance can be realized. However, the SEI films have not only structures that vary depending on a variety of factors such as the compositions of electrolytic solutions, charge and discharge temperatures, and charge and discharge potentials but also diverse stability.

There are a variety of causes for shortening the service lives of batteries, and it is considered that metal ions that are eluted into electrolytic solutions have a particularly serious influence on the service lives of batteries such as short-circuiting caused by the breakage of SEI films or the precipitation of metal.

The present invention has been made in consideration of the above-described circumstances, and an object of the present invention is to provide a cathode material for a lithium-ion secondary battery capable of improving cathode densities while guaranteeing electron conductivity and a manufacturing method thereof, a cathode for a lithium-ion secondary battery, and a lithium-ion secondary battery.

The present inventors carried out intensive studies in order to achieve the above-described object, and consequently found a cathode material for a lithium-ion secondary battery including active material secondary particles formed by aggregating central particles including primary particles of a cathode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5) and a carbonaceous film, in which at least a portion of surfaces of the primary particles are coated with the carbonaceous film and the carbonaceous film is obtained by thermal decomposition of an organic compound, in which in a charge and discharge cycle test at 60° C. of the lithium-ion secondary battery comprising a cathode including the active material secondary particles and an anode made of graphite, the amount of the element represented by A, which penetrates into or is precipitated on the anode after 500 cycles, is set to 600 ppm or less with respect to a mass of the active material secondary particles. The inventors also found the cathode materials for a lithium-ion secondary battery capable of improving cathode densities while guaranteeing electron conductivity, and completed the present invention.

A cathode material for a lithium-ion secondary battery of the present invention including active material secondary particles formed by aggregating central particles including primary particles of a cathode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5) and a carbonaceous film, in which at least a portion of surfaces of the primary particles are coated with the carbonaceous film, and the carbonaceous film is obtained by thermal decomposition of an organic compound, in which, in a charge and discharge cycle test at 60° C. of the lithium-ion secondary battery including the cathode including the active material secondary particles and an anode made of graphite, an amount of the element represented by A, which is penetrates into or precipitated on the anode after 500 cycles, is 600 ppm or less with respect to a mass of the active material secondary particles.

A cathode for the lithium-ion secondary battery of the present invention is a cathode for a lithium-ion secondary battery including an electrode current collector and a cathode mixture layer formed on the electrode current collector, in which the cathode mixture layer includes the cathode material for the lithium-ion secondary battery of the present invention.

A lithium-ion secondary battery of the present invention includes the cathode for the lithium-ion secondary battery of the present invention.

A method for manufacturing a cathode material for the lithium-ion secondary battery of the present invention includes a step of preparing a slurry including the organic compound which serves as a carbon source and at least one of the cathode active material and a precursor which is turned into the cathode active material by heating and a step of thermally treating the slurry at 400° C. or higher and 650° C. or lower in a non-oxidative atmosphere.

According to the cathode material for a lithium-ion secondary battery of the present invention, it is possible to provide a cathode material for a lithium-ion secondary battery capable of improving cathode densities while guaranteeing electron conductivity.

According to the cathode for a lithium-ion secondary battery of the present invention, since the cathode material for a lithium-ion secondary battery of the present invention is included, a lithium-ion secondary battery having a high energy density and excellent input and output characteristics can be obtained.

According to the lithium-ion secondary battery of the present invention, since the cathode for a lithium-ion secondary battery of the present invention is included, a lithium-ion secondary battery having a high energy density and excellent input and output characteristics can be obtained.

According to the method for manufacturing a cathode material for a lithium-ion secondary battery of the present invention, it is possible to provide a cathode material for a lithium-ion secondary battery capable of improving cathode densities while guaranteeing electron conductivity.

### BRIEF DESCRIPTION OF THE DRAWINGS

FIG. 1 is a perspective view illustrating a container for thermal treatments which is used for thermal treatments in examples and comparative examples.

### DETAILED DESCRIPTION OF THE INVENTION

Embodiments of a cathode material for a lithium-ion secondary battery and a manufacturing method thereof, a cathode for a lithium-ion secondary battery, and a lithium-ion secondary battery of the present invention will be described.

Meanwhile, the present embodiment is specific description for better understanding of the gist of the invention and does not limit the present invention unless particularly otherwise described.

Cathode Material for Lithium-Ion Secondary Battery

A cathode material for a lithium-ion secondary battery of the present embodiment (hereinafter, in some cases, simply referred to as “cathode material”) includes active material secondary particles formed by aggregating central particles including primary particles of a cathode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5) and a carbonaceous film, wherein at least a portion of surfaces of the primary particles are coated with the carbonaceous film, and the carbonaceous film is obtained by thermal decomposition of an organic compound, in which, in a charge and discharge cycle test at 60° C. of the lithium-ion secondary battery including a cathode including the active material secondary particles and an anode made of graphite, the amount of the element (ion) represented by A which penetrates into or is precipitated on the anode after 500 cycles, is 600 ppm or less with respect to the mass of the active material secondary particles.

The charge and discharge cycle test at 60° C. of a lithium-ion secondary battery including the cathode including the active material secondary particles and the anode made of graphite refers to a test including forming the lithium-ion secondary battery including the cathode including the active material particles in the present embodiment and the anode made of graphite and evaluating the cycle charging and discharging characteristics at 60° C. of the lithium-ion secondary battery.

The conditions of the charge and discharge cycle test are as described below.

First, three cycles of charging and discharging are carried out at a charging/discharging current set to 0.1 C, thereby activating the battery.

After that, 500 cycles of the charge and discharge cycle test is carried out at the respective charging/discharging currents set to 2 C.

The charging and discharging voltage is set to 2.5 V to 4.4 V.

The test is all carried out at 60° C.

The method for measuring the amount of the element (ion) represented by A, which penetrates into or is precipitated on the anode, is as described below.

After the charge and discharge cycle test, the cell is disassembled, the anode is cleaned with diethyl carbonate, and then a quantitative analysis of the element (ion) in the anode is carried out according to JAERI-M 93-013 “Analysis of High Purity Graphite” using an inductively coupled plasma (ICP) emission spectrometric analyzer.

The average primary particle diameter of the primary particles of the cathode active material in the present embodiment is preferably 0.01 μm or more and 20 μm or less and more preferably 0.03 μm or more and 0.5 μm or less.

When the average primary particle diameter of the primary particles of the cathode active material is 0.01 μm or more, the specific surface area of the primary particles of the cathode active material increases, and thus it is possible to suppress an increase in the mass of necessary carbon and suppress a decrease in the charge and discharge capacity of the lithium-ion secondary battery. On the other hand, when the average primary particle diameter of the primary particles of the cathode active material is 20 μm or less, it is possible to suppress an increase in the migration distance of lithium ions or electrons in the cathode material. Therefore, the deterioration of output characteristics caused by an increase in the internal resistance of the lithium-ion secondary battery can be suppressed.

The average secondary particle diameter of the cathode material for a lithium-ion secondary battery (active material secondary particles) of the present embodiment is preferably 0.1 μm or more and 60 μm or less and more preferably 2 μm or more and 60 μm or less.

When the average secondary particle diameter of the cathode material is 0.1 μm or more, the amount of a binder resin necessary to produce the cathode for a lithium-ion secondary battery is not excessive. On the other hand, when the average secondary particle diameter of the cathode material is 60 μm or less, it is possible to suppress the occurrence of the poor intrusion of electrolytic solutions into the secondary battery. In addition, it is possible to suppress the generation of marks or lines during coating.

Here, the average particle diameter refers to a volume-average particle diameter. The average primary particle diameter of the primary particles of the cathode active material and the average secondary particle diameter of the cathode material (active material secondary particles) can be measured using a laser diffraction and scattering particle size distribution measurement instrument or the like. In addition, it is also possible to arbitrarily select a plurality of primary particles or secondary particles observed using a scanning electron microscope (SEM) and compute the average particle diameter of the primary particles or the secondary particles.

The amount of carbon included in the cathode material for a lithium-ion secondary battery, that is, the amount of carbon that forms the carbonaceous film is preferably 0.6 parts by mass or more and 2.0 parts by mass or less and more preferably 0.8 parts by mass or more and 1.5 parts by mass or less with respect to 100 parts by mass of the central particles.

When the amount of carbon is 0.6 parts by mass or more, electron conduction can be ensured even at a high charge-discharge rate of lithium-ion secondary batteries, and it is possible to realize sufficient charge and discharge rate performance. On the other hand, when the amount of carbon is 2.0 parts by mass or less, it is possible to suppress the battery capacity of lithium-ion secondary batteries per unit mass of the cathode material being decreased more than necessary.

The carbon supporting amount with respect to the surface area of the primary particles of the cathode active material constituting the cathode material for a lithium-ion secondary battery (“[the carbon supporting amount]/[the surface area of the primary particles of the cathode active material]”; hereinafter, referred to as “the carbon supporting amount ratio”) is preferably 0.5 mg/m² or more and 1.2 mg/m² or less and more preferably 0.55 mg/m² or more and 1 mg/m² or less.

When the carbon supporting amount ratio is 0.5 mg/m² or more, the discharge capacity of lithium-ion secondary batteries at a high charge-discharge rate increases, and it is possible to realize sufficient charge and discharge rate performance. On the other hand, when the carbon supporting amount ratio is 1.2 mg/m² or less, it is possible to suppress the battery capacity of lithium-ion secondary batteries per unit mass of the electrode material being decreased more than necessary.

The BET specific surface area of the cathode material for a lithium-ion secondary battery is preferably 5 m²/g or more and 20 m²/g or less.

When the BET specific surface area is 5 m²/g or more, the coarsening of the cathode material is suppressed, and thus it is possible to increase the diffusion rate of lithium ions among the particles. Therefore, it is possible to improve the battery characteristics of lithium-ion secondary batteries. On the other hand, when the BET specific surface area is 20 m²/g or less, it is possible to increase the electrode density in cathodes including the cathode material for a lithium-ion secondary battery of the present embodiment. Therefore, it is possible to provide lithium-ion secondary batteries having a high energy density.

The structure of the carbonaceous film in the cathode material of the present embodiment may not be clear; however, in the structure, the total volume of micropores in the carbonaceous film observed in a range of 0.8 nm or less of the micropore diameters measured by a gas adsorption method is 0.15 cm³ or more and 0.35 cm³ or less per (g) mass of the carbonaceous film.

The micropores in the carbonaceous film in the cathode material are measured by a gas adsorption method. The volume of micropores in the carbonaceous film that are observed in a range of 0.8 nm or less of the micropore diameters is obtained from analyses using the Horvath-Kawazoe (HK) method. With an assumption that micropores are all present in the carbonaceous film, the total volume of micropores in the carbonaceous film that are observed in a rage of 0.8 nm or less of the micropore diameters is computed from the obtained volume of the micropores and the amount of carbon.

When the total volume of the micropores is in the above-described range, it is possible to ensure sufficient electron conductivity and sufficient diffusivity of lithium ions and suppress the elution of metal ions that are eluted from the surfaces of active material particles. Excellent carbonaceous films are considered to be formed. As a result, cathode materials having a long service life and excellent output characteristics can be obtained.

Cathode Active Material

The cathode active material constituting the cathode material for a lithium-ion secondary battery of the present embodiment is generally made of an electrode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5).

Examples of a compound represented by General Formula LiₐAₓBO₄ include lithium iron phosphate (LiFePO₄), lithium manganese phosphate (LiMnPO₄), Li₂FeSiO₄, Li₂MnSiO₄, Li₂Fe₂ (SO₄)₃, and the like.

The shape of the primary particles (the primary particles of the cathode active material coated with the carbonaceous film) of the central particles constituting the cathode material for a lithium-ion secondary battery of the present embodiment is not particularly limited, but the shape of the primary particles of the central particles is preferably a spherical shape since it is easy to generate cathode materials made of spherical, particularly, truly spherical agglomerates.

When the shape of the primary particles of the central particles is a spherical shape, it is possible to decrease the amount of a solvent when cathode material paste is prepared by mixing the cathode material for a lithium-ion secondary battery, a binder resin (binding agent), and a solvent. Furthermore, when the shape of the primary particles of the central particles is a spherical shape, it becomes easy to apply the cathode material paste to electrode current collectors. Furthermore, when the shape of the primary particles of the central particles is a spherical shape, the surface area of the primary particles of the central particles is minimized, and thus it is possible to minimize the amount of the binder resin (binding agent) blended into the cathode material paste. As a result, it is possible to decrease the internal resistance of cathodes for which the cathode material for a lithium-ion secondary battery of the present embodiment is used. In addition, when the shape of the primary particles of the central particles is a spherical shape, it becomes easy to closely pack the cathode material, and thus the amount of the cathode material for a lithium-ion secondary battery packed per unit volume of the cathode increases. As a result, it is possible to increase the electrode density, and high-capacity lithium-ion secondary batteries can be obtained.

Carbonaceous Film

The surfaces of the primary particles of the cathode active material is coated with the carbonaceous film.

When the surfaces of the primary particles of the cathode active material are coated with the carbonaceous film, it is possible to improve the electron conductivity of the cathode material for a lithium-ion secondary battery.

The thickness of the carbonaceous film is preferably 0.5 nm or more and 7.0 nm or less and more preferably 0.9 nm or more and 3.0 nm or less.

When the thickness of the carbonaceous film is 0.5 nm or more, it is possible to prevent the excessively thin thickness of the carbonaceous film from disabling the formation of films having a desired resistance value. In addition, it is possible to ensure conductivity suitable for the cathode material for a lithium-ion secondary battery. On the other hand, when the thickness of the carbonaceous film is 7.0 nm or less, it is possible to suppress a decrease in the battery capacity per unit mass of the cathode material for a lithium-ion secondary battery, and additionally, it is possible to suppress an increase in resistance caused by the hindrance of diffusion by shortening the diffusion distance of lithium ions.

In addition, when the thickness of the carbonaceous film is 0.5 nm or more and 7.0 nm or less, it becomes easy to closely pack the cathode material for a lithium-ion secondary battery, and thus the amount of the cathode material for a lithium-ion secondary battery packed per unit volume of the cathode increases. As a result, it is possible to increase the electrode density, and high-capacity lithium-ion secondary batteries can be obtained.

The coating ratio of the carbonaceous film with respect to the primary particles of the cathode active material is preferably more than 80% and more preferably 90% or more.

When the coating ratio of the carbonaceous film is more than 80%, the coating effect of the carbonaceous film can be sufficiently obtained.

According to the cathode material for a lithium-ion secondary battery of the present embodiment, in the charge and discharge cycle test at 60° C. of the lithium-ion secondary battery which is made of active material secondary particles formed by collecting central particles including the primary particles of the cathode active material represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5) and the carbonaceous film with which at least some of the surfaces of the primary particles are coated and which is obtained by thermal decomposition of an organic compound and includes the cathode including active material secondary particles and the anode made of graphite, when the amount of an element (ion) represented by A which is dissolved or precipitated in the anode after 500 cycles is set to 600 ppm or less with respect to the mass of the active material secondary particles, it is possible to provide cathode materials for a lithium-ion secondary battery capable of improving cathode densities while guaranteeing electron conductivity, and completed the present invention.

Method for Manufacturing Cathode Material for Lithium-Ion Secondary Battery

Method for Manufacturing Cathode Material

A method for manufacturing a cathode material of the present embodiment includes, for example, a step of manufacturing at least one of a cathode active material and a precursor of the cathode active material (cathode active material-manufacturing step), a step of preparing a slurry including an organic compound which serves as a carbon source, at least one of the cathode active material and the precursor of the cathode active material, and water by mixing the above-described components (slurry preparation step), and a step of thermally treating the slurry at 400° C. or higher and 650° C. or lower in a non-oxidative atmosphere (thermal treatment step).

Step of Manufacturing Cathode Active Material and Precursor of Cathode Active Material

As a method for manufacturing a compound (the cathode active material) represented by General Formula LiₐAₓBO₄ (here, A represents at least one element selected from the group consisting of Mn, Fe, Co, and Ni, B represents at least one element selected from the group consisting of P, Si, and S, 0≤a<4, and 0<x<1.5), a method of the related art such as a solid phase method, a liquid phase method, and a gas phase method is used. Examples of LiₐAₓBO₄ obtained using the above-described method include particulate substances (hereinafter, in some cases, referred to as “LiₐAₓBO₄ particles”).

The LiₐAₓBO₄ particles are obtained by, for example, hydrothermally synthesizing a slurry-form mixture obtained by mixing a Li source, an A source, a B source, and water. By means of hydrothermal synthesis, LiₐAₓBO₄ is generated as a precipitate in water. The obtained precipitate may be a precursor of LiₐAₓBO₄. In this case, target LiₐAₓBO₄ particles are obtained by calcinating the precursor of LiₐAₓBO₄.

In this hydrothermal synthesis, a pressure-resistant airtight container is preferably used.

Here, examples of the Li source include lithium salts such as lithium acetate (LiCH₃COO) and lithium chloride (LiCl), lithium hydroxide (LiOH), and the like. Among these, as the Li source, at least one selected from the group consisting of lithium acetate, lithium chloride, and lithium hydroxide is preferably used. In addition, in a case in which the Li source and the P source are the same substance, for example, trilithium phosphate (Li₃PO₄).

Examples of the A source include chlorides, carboxylates, sulfates, and the like which include at least one element selected from the group consisting of Mn, Fe, Co, and Ni. For example, in a case in which A in LiₐAₓBO₄ is Fe, examples of the Fe source include divalent iron salts such as iron (II) chloride (FeCl₂), iron (II) acetate (Fe(CH₃COO)₂), and iron (II) sulfate (FeSO₄). In addition, in a case in which A in LiₐAₓBO₄ is Mn, examples of the Mn source include divalent manganese salts such as manganese (II) chloride (MnCl₂), manganese (II) acetate (Mn(CH₃COO)₂), and manganese (II) sulfate (MnSO₄).

Examples of the B source include chlorides, carboxylates, sulfates, and the like which include at least one element selected from the group consisting of P, Si, and S.

For example, in a case in which Bin LiₐAₓBO₄ is P, examples of the P source include phosphoric acid compounds such as phosphoric acid (H₃PO₄), ammonium dihydrogen phosphate (NH₄H₂PO₄), diammonium hydrogen phosphate ((NH₄)₂HPO₄), and the like. Among these, as the P source, at least one selected from the group consisting of phosphoric acid, ammonium dihydrogen phosphate, and diammonium hydrogen phosphate is preferably used.

Slurry Preparation Step

By means of the slurry preparation step, the organic compound which is the precursor of the carbonaceous film is interposed among the primary particles of the cathode active material, and the organic compound and the central particles are uniformly mixed together, and thus it is possible to uniformly coat the surfaces of the primary particles of the cathode active material with the organic compound.

The organic compound that is used in the method for manufacturing the cathode material in the present embodiment is not particularly limited as long as the compound is capable of forming the carbonaceous film on the surface of the cathode active material. Examples of the above-described organic compound include divalent alcohols such as polyvinyl alcohol (PVA), polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, and ethylene glycol, trivalent alcohols such as glycerin, and the like.

In the slurry preparation step, the cathode active material raw material and the organic compound are dissolved or dispersed in water, thereby preparing a homogeneous slurry.

In the dissolution or dispersion of these raw materials in water, it is also possible to add a dispersant thereto.

A method for dissolving or dispersing the cathode active material raw material and the organic compound in water is not particularly limited as long as the cathode active material raw material is dispersed in water and the organic compound is dissolved or dispersed in water. The above-described method is preferably a method in which a medium stirring-type dispersion device that stirs medium particles at a high rate such as a planetary ball mill, an oscillation ball mill, a bead mill, a paint shaker, or an attritor is used.

When the cathode active material raw material and the organic compound are dissolved or dispersed in water, it is preferable to disperse the cathode active material raw material in water in a primary particle form, then, add the organic compound to water, and stir the organic compound so as to be dissolved or dispersed. In such a case, the surfaces of the primary particles of the cathode active material raw material are easily coated with the organic compound. Therefore, the organic compound is uniformly dispersed on the surfaces of the primary particles of the cathode active material raw material, and consequently, the surfaces of the primary particles of the cathode active material are coated with the carbonaceous film derived from the organic compound.

Thermal Treatment Step

Next, the slurry prepared in the slurry preparation step is sprayed and dried in a high-temperature atmosphere, for example, in the atmosphere of 70° C. or higher and 250° C. or lower.

Next, the obtained dried substance is thermally treated (calcinated) in a non-oxidative atmosphere at a temperature of preferably 400° C. or higher and 650° C. or lower and more preferably 500° C. or higher and 650° C. or lower for 1 hour or longer and 250 hours or shorter.

The non-oxidative atmosphere is preferably an atmosphere filled with an inert gas such as nitrogen (N₂), argon (Ar), or the like. In a case in which it is necessary to further suppress the oxidation of the dried substance, a reducing atmosphere including approximately several percentages by volume of a reducing gas such as hydrogen (H₂) is preferred. In addition, for the purpose of removing organic components evaporated in the non-oxidative atmosphere during the calcination, a susceptible or burnable gas such as oxygen (O₂) may be introduced into the non-oxidative atmosphere.

Here, when the calcination temperature is set to 400° C. or higher, it is easy for the organic compound in the dried substance to be sufficiently decomposed and reacted, and the organic compound is easily and sufficiently carbonized. As a result, it is easy to prevent the generation of a high-resistance decomposed substance of the organic compound in the obtained cathode material (active material secondary particles). Meanwhile, when the calcination temperature is set to 650° C. or lower, lithium (Li) in the cathode active material raw material is not easily evaporated, and the particle growth of the primary particles of the cathode active material to a size that is equal to or larger than the target size is suppressed. As a result, in a case in which lithium-ion secondary batteries including an electrode including the electrode material of the present embodiment are produced, it is possible to prevent the discharge capacity at a high charge-discharge rate from decreasing, and it is possible to realize lithium-ion secondary batteries having sufficient charge and discharge rate performance.

By means of the above-described steps, a cathode material (active material secondary particles) formed by collecting the central particles in which the surfaces of the primary particles of the cathode active material are coated with carbon (the carbonaceous film) generated by the thermal decomposition of the organic compound in the dried substance are obtained.

Cathode for Lithium-Ion Secondary Battery

A cathode for a lithium-ion secondary battery of the present embodiment (hereinafter, in some cases, referred to as “cathode”) includes the cathode material for a lithium-ion secondary battery of the present embodiment. In more detail, the cathode of the present embodiment includes an electrode current collector made of a metal foil and a cathode mixture layer formed on the electrode current collector, and the cathode mixture layer includes the cathode material for a lithium-ion secondary battery of the present embodiment. That is, the cathode of the present embodiment is obtained by forming a cathode mixture layer on one main surface of the electrode current collector using the cathode material for a lithium-ion secondary battery of the present embodiment.

Since the cathode for a lithium-ion secondary battery of the present embodiment includes the cathode material for a lithium-ion secondary battery of the present embodiment, lithium-ion secondary batteries for which the cathode for a lithium-ion secondary battery of the present embodiment is used have a high energy density and have excellent input and output characteristics.

Method for Manufacturing Cathode for Lithium-Ion Secondary Battery

The method for manufacturing the cathode for a lithium-ion secondary battery of the present embodiment is not particularly limited as long as the cathode mixture layer can be formed on one main surface of the electrode current collector using the cathode material for a lithium-ion secondary battery of the present embodiment. Examples of the method for manufacturing the cathode of the present embodiment include the following method.

First, the cathode material for a lithium-ion secondary battery of the present embodiment, a binding agent made of a binder resin, and a solvent are mixed together, thereby preparing cathode material paste. At this time, to the cathode material paste in the present embodiment, a conductive auxiliary agent such as carbon black may be added if necessary.

Binding Agent

As the binding agent, that is, the binder resin, for example, a polytetrafluoroethylene (PTFE) resin, a polyvinylidene fluoride (PVdF) resin, fluorine rubber, or the like is preferably used.

The blending amount of the binding agent used to prepare the cathode material paste is not particularly limited and is, for example, preferably 1 part by mass or more and 30 parts by mass or less and more preferably 3 parts by mass or more and 20 parts by mass or less with respect to 100 parts by mass of the cathode material for a lithium-ion secondary battery.

When the blending amount of the binding agent is 1 part by mass or more, it is possible to sufficiently improve the binding property between the cathode mixture layer and the electrode current collector. Therefore, it is possible to prevent the cathode mixture layer from being cracked or dropped during the formation of the cathode mixture layer by means of rolling or the like. In addition, it is possible to prevent the cathode mixture layer from being peeled off from the electrode current collector in processes of charging and discharging lithium-ion secondary batteries and prevent the battery capacity or the charge-discharge rate from being decreased. On the other hand, when the blending amount of the binding agent is 30 parts by mass or less, it is possible to prevent the internal resistance of the cathode material for a lithium-ion secondary battery from being decreased and prevent the battery capacity at a high charge-discharge rate from being decreased.

Conductive Auxiliary Agent

The conductive auxiliary agent is not particularly limited, and, for example, at least one element selected from the group consisting of particulate carbon such as acetylene black (AB), KETJEN BLACK, and furnace black and fibrous carbon such as vapor-grown carbon fiber (VGCF) and carbon nanotube is used.

Solvent

The solvent that is used in the cathode material paste including the cathode material for a lithium-ion secondary battery of the present embodiment is appropriately selected depending on the properties of the binding agent. When the solvent is appropriately selected, it is possible to facilitate the cathode material paste to be applied to substances to be coated such as the electrode current collector.

Examples of the solvent include water, alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diehtylene glycol monoethyl ether, ketones such as acetone, methyl ethyl ketone (MEK), methyl isobutyl ketone (MIBK), acetylacetone, and cyclohexanone, amides such as dimethyl formamide, N,N-dimethylacetoacetamide, and N-methyl-2-pyrrolidone (NMP), glycols such as ethylene glycol, diethylene glycol, and propylene glycol, and the like. These solvents may be used singly, or a mixture of two or more solvents may be used.

The content rate of the solvent in the cathode material paste is preferably 50% by mass or more and 70% by mass or less and more preferably 55% by mass or more and 65% by mass or less in a case in which the total mass of the cathode material for a lithium-ion secondary battery of the present embodiment, the binding agent, and the solvent is set to 100% by mass.

When the content rate of the solvent in the cathode material paste is in the above-described range, it is possible to obtain cathode material paste having excellent electrode formability and excellent battery characteristics.

A method for mixing the cathode material for a lithium-ion secondary battery of the present embodiment, the binding agent, the conductive auxiliary agent, and the solvent is not particularly limited as long as these components can be uniformly mixed together. Examples thereof include mixing methods in which a kneader such as a ball mill, a sand mill, a planetary mixer, a paint shaker, or a homogenizer is used.

The cathode material paste is applied to one main surface of the electrode current collector so as to form a coated film, and then this coated film is dried, thereby obtaining the electrode current collector having a coated film made of a mixture of the cathode material and the binding agent formed on one main surface.

After that, the coated film is pressed by pressure and is dried, thereby obtaining a cathode having the cathode mixture layer on one main surface of the electrode current collector.

Lithium-Ion Secondary Battery

A lithium-ion secondary battery of the present embodiment includes a cathode, an anode, and a non-aqueous electrolyte, in which the cathode is the cathode for a lithium-ion secondary battery of the present embodiment. Specifically, the lithium-ion secondary battery of the present embodiment includes the cathode for a lithium-ion secondary battery of the present embodiment as a cathode, an anode, a separator, and a non-aqueous electrolyte.

In the lithium-ion secondary battery of the present embodiment, the anode, the non-aqueous electrolyte, and the separator are not particularly limited.

Anode

Examples of the anode include anodes including an anode material such as Li metal, carbon materials such as natural graphite and hard carbon, Li alloys, Li₄Ti₅O₁₂, Si(Li_{4A}Si), and the like.

Non-Aqueous Electrolyte

Examples of the non-aqueous electrolyte include non-aqueous electrolytes obtained by mixing ethylene carbonate (EC) and ethyl methyl carbonate (EMC) so that the volume ratio reaches 1:1 and dissolving lithium hexafluorophosphate (LiPF₆) in the obtained solvent mixture so that the concentration reaches 1 mol/dm³.

Separator

As the separator, it is possible to use, for example, porous propylene.

In addition, instead of the non-aqueous electrolyte and the separator, a solid electrolyte may be used.

Since the lithium-ion secondary battery of the present embodiment includes the cathode for a lithium-ion secondary battery of the present embodiment as the cathode, the lithium-ion secondary battery has a high energy density and has excellent input and output characteristics.

### EXAMPLES

Hereinafter, the present invention will be more specifically described using examples and comparative examples, but the present invention is not limited to the following examples.

### Example 1

Synthesis of Cathode Material for Lithium-Ion Secondary Battery

Li₃PO₄ as a Li source and a P source and FeSO₄.7H₂O as an Fe source were used and mixed into pure water so that the mass ratio reached 3:1:1 (Li/Fe/P), thereby preparing a uniform precursor slurry. The amount of Fe used was 30 mol, and the amount of FeSO₄.7H₂O was 8.34 kg.

Next, this precursor slurry was stored in a pressure-resistant airtight container and was hydrothermally synthesized at 210° C. for 15 hours.

After this reaction, the slurry was cooled to room temperature, thereby obtaining a precipitated cake-state reaction product.

This reaction product was cleaned with distilled water a plurality of times and was held at a water content ratio of 30% so as to prevent the reaction product from being dried, thereby producing a cake-form substance.

Powder obtained by sampling a small amount of this cake-form substance and drying the cake-form substance in a vacuum at 70° C. for two hours was analyzed using an X-ray diffraction apparatus (trade name: X'Pert, manufactured by PANalytical B. V.). As a result, it was confirmed that single-phase LiFePO₄ was formed.

Next, the obtained LiFePO₄ (4 kg), lactose (0.2 kg) as a carbon source, and water were mixed together so that the total weight reached 20 kg, and this mixture was crushed and mixed using zirconia balls (30 kg) having a diameter of 5 mm as medium particles in a ball mill, thereby preparing a uniform slurry.

Next, this slurry was dried using a spray dryer and was granulated.

Next, the obtained granulated body was thermally treated in a nitrogen atmosphere.

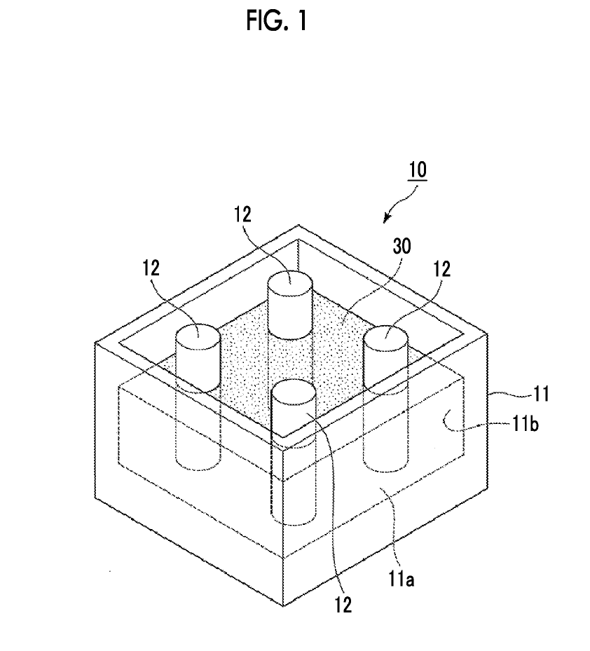

For the thermal treatment, a container for thermal treatments as illustrated in FIG. 1 was used. The granulated body was thermally treated at a temperature-increase rate of 20° C./min and 500° C. for five hours using this container for thermal treatments, thereby obtaining a cathode material (A1-500) in which the surface of LiFePO₄ was coated with a carbonaceous film. In addition, thermal treatments were carried out in the same manner at thermal treatment temperatures of 400° C., 550° C., 600° C., and 650° C., thereby obtaining cathode materials (A1-400, A1-550, A1-600, and A1-650).

A container for thermal treatments 10 includes a container main body 11 and heat conductors 12, 12, 12, and 12 which are provided so as to protrude from an inner bottom surface 11a of the container main body 11 and are made of solid bodies forming a cylindrical shape.

The heat conductor 12 is vertically provided with respect to the inner bottom surface 11a of the container main body 11 and is disposed in a height direction (a thickness direction in the containing main body 11) of the container main body 11.

The disposition of the heat conductors 12, 12, 12, and 12 is not particularly limited; however, for example, the heat conductors 12, 12, 12, and 12 are disposed so that heat can be uniformly transferred to the dried substance (granulated body) 30 stored in the container main body 11 through the heat conductors 12, 12, 12, and 12.

The heat conductor 12 is made of a material having a higher thermal conductivity than the dried substance (granulated body) 30. The container main body 11 and the heat conductor 12 are preferably made of the same material. For the container main body 11 and the heat conductor 12, carbon-based materials are preferably used from the viewpoint of ease of processing, inexpensive prices, and high thermal conductivity.

In addition, in the container main body 11, in a case in which the sum of the apparent areas of the container main body 11 and the heat conductor 12 in contact with the dried substance (mixture) 30 is represented by A, and the apparent volume of the dried substance (granulated body) 30 is represented by V, the ratio (V/A) of the volume V to the sum A is 2.5 or less. When the ratio (V/A) of the volume V to the sum A exceeds 2.5, it becomes impossible to uniformly transfer heat to the entire dried substance (granulated body) 30 stored in the container main body 11 through the heat conductor 12.

Production of Lithium-Ion Secondary Battery

The cathode material (A1-400, A1-500, A1-550, A1-600, or A1-650), polyvinylidene fluoride (PVdF) as a binding agent, and acetylene black (AB) as a conductive auxiliary agent were added to N-methyl-2-pyrrolidone (NMP) which was a solvent so that the mass ratio (the cathode material/PVdF/AB) reached 90:5:5, and the components were mixed together, thereby preparing cathode material paste (for the cathode) using a kneader (trade name: AWATORI RENTARO, manufactured by Thinky Corporation).

This cathode material paste (for the cathode) was applied onto the surface of a 30 μm-thick aluminum foil (electrode current collector) so as to form a coated film, and the coated film was dried, thereby forming a cathode mixture layer on the surface of the aluminum foil.

After that, the cathode mixture layer was pressed by pressure so as to obtain a predetermined density, thereby producing a cathode of Example 1. This cathode was punched so as to have a plate shape including a square of 3 cm×3 cm provided with the coated surface and a region for attaching electrode tabs outside of the square, and the electrode tabs were welded to the region for attaching, thereby producing an electrode for testing of Example 1.

A coated electrode was disposed as an anode with respect to this electrode for testing through a separator made of a porous polypropylene film, thereby producing a member for a battery.

The coated electrode was formed by applying a mixture obtained by mixing natural graphite, acetylene black (AB), styrene-butadiene rubber (SBR), and carboxymethyl cellulose (CMC) so that the mass ratio reached 92:4:3:1 (natural graphite/AB/SBR/CMC) onto the separator.

Meanwhile, ethylene carbonate and ethyl methyl carbonate were mixed together in a volume ratio of 3:7, and furthermore, 1 mol/L of a LiPF₆ solution was added thereto, thereby producing an electrolyte solution having lithium ion conductivity.

A laminate-type cell was produced using the electrode for testing manufactured as described above (cathode), the anode, and the electrolyte solution and was considered as a lithium-ion secondary battery (a) of Example 1.

In addition, a lithium-ion secondary battery (b) of Example 1 was produced in the same manner as described above except for the fact that an electrolyte solution to which vinylene carbonate (VC) was added so that the content in the electrolyte solution reached 2% by volume was used.

### Example 2

A cathode material (A2) in which the surface of LiFePO₄ was coated with a carbonaceous film was obtained in the same manner as in Example 1 except for the fact that the conditions of the thermal treatment were the temperature-increase rate of 20° C./min, 500° C., and ten hours.

Lithium-ion secondary batteries (a) and (b) of Example 2 were produced in the same manner as in Example 1 except for the fact that the cathode material (A2) was used.

### Example 3

A cathode material (A3) in which the surface of LiFePO₄ was coated with a carbonaceous film was obtained in the same manner as in Example 1 except for the fact that the conditions of the thermal treatment were the temperature-increase rate of 20° C./min, 400° C., and ten hours.

Lithium-ion secondary batteries (a) and (b) of Example 3 were produced in the same manner as in Example 1 except for the fact that the cathode material (A3) was used.

### Example 4

Li₃PO₄ as a Li source and a P source, FeSO₄.7H₂O as an Fe source, and MnSO₄.H₂O as a Mn source were used and mixed into pure water so that the mass ratio reached 3:0.25:0.75:1 (Li/Fe/Mn/P), thereby preparing a uniform precursor slurry. The total amount of Fe and Mn used was 30 mol, the amount of FeSO₄.7H₂O was 2.1 kg, and the amount of MnSO₄.H₂O was 3.8 kg.

Next, this precursor slurry was stored in a pressure-resistant airtight container and was hydrothermally synthesized at 210° C. for 15 hours.

After this reaction, the slurry was cooled to room temperature, thereby obtaining a precipitated cake-state reaction product.

This reaction product was cleaned with distilled water a plurality of times and was held at a water content ratio of 30% so as to prevent the reaction product from being dried, thereby producing a cake-form substance.

Powder obtained by sampling a small amount of this cake-form substance and drying the cake-form substance in a vacuum at 70° C. for two hours was analyzed using an X-ray diffraction apparatus (trade name: X'Pert, manufactured by PANalytical B. V.). As a result, it was confirmed that Li[Fe_{0.25}Mn_{0.75}]PO₄ was formed.

A cathode material (A4) in which the surface of Li[Fe_{0.25}Mn_{0.75}]PO₄ was coated with a carbonaceous film was obtained in the same manner as in Example 1 except for the fact that Li[Fe_{0.25}Mn_{0.75}]PO₄ was used.

Lithium-ion secondary batteries (a) and (b) of Example 4 were produced in the same manner as in Example 1 except for the fact that the cathode material (A4) was used.

### Comparative Example 1

Cathode materials (B1-350, B1-725, B1-775, and B1-800) in which the surface of LiFePO₄ was coated with a carbonaceous film was obtained in the same manner as in Example 1 except for the fact that the thermal treatment temperatures were set to 350° C., 725° C., 775° C., and 800° C.

Lithium-ion secondary batteries (a) and (b) of Comparative Example 1 were produced in the same manner as in Example 1 except for the fact that the cathode materials (B1-350, B1-725, B1-775, and B1-800) were used.

### Comparative Example 2

A cathode material (B2) in which the surface of Li[Fe_{0.25}Mn_{0.75}]PO₄ was coated with a carbonaceous film was obtained in the same manner as in Example 4 except for the fact that the conditions of the thermal treatment were the temperature-increase rate of 20° C./min, 800° C., and five hours.

Lithium-ion secondary batteries (a) and (b) of Comparative Example 2 were produced in the same manner as in Example 1 except for the fact that the cathode material (B2) was used.

Evaluation of Cathode Material for Lithium-Ion Secondary Battery and Lithium-Ion Secondary Battery

The cathode material for a lithium-ion secondary battery and the lithium-ion secondary batteries of Examples 1 to 4 and Comparative Examples 1 and 2 were evaluated as described below.

1. Amount of Carbon

The amount of carbon in the cathode material for a lithium-ion secondary battery was measured using a carbon/sulfur analyzer (trade name: EMIA-810W, manufactured by Horiba Ltd.).

2. Micropore Diameter Distribution

Micropores in the carbonaceous film in the cathode material for a lithium-ion secondary battery were measured using a gas adsorption method. The volume of micropores observed in a region in which micropore diameters were 0.8 nm or less in the carbonaceous film was obtained from analyses in which the HK method was used. With an assumption that micropores were all present in the carbonaceous film, the total volume of micropores that are observed in a region in which micropore diameters are 0.8 nm or less in the carbonaceous film was computed from the obtained volume of the micropores and the amount of carbon.

3. Charge and Discharge Cycle Test

The charge and discharge cycle test was carried out as described below.

First, three cycles of charging and discharging were carried out at a charging/discharging current set to 0.1 C, thereby activating the battery.

After that, 500 cycles of the charge and discharge cycle test was carried out at the respective charging/discharging currents set to 2 C. The charging and discharging voltage was set to 2.5 V to 4.1 V (A1, A2, A3, and B1) in the case of LiFePO₄ and was set to 2.5 V to 4.4 V (A4 and B2) in the case of Li[Fe_{0.25}Mn_{0.75}]PO₄.

The test was all carried out at 60° C.

The ratio (C500/C1) of the 2 C discharge capacity (C500) after 500 cycles to the 2 C discharge capacity (C1) after the activation was considered as the capacity retention.

4. Determination of Weight of Eluted Metal

After the charge and discharge cycle test, the cell was disassembled, the anode was cleaned with diethyl carbonate, and then quantitative analyses of the iron (Fe) and the manganese (Mn) were carried out according to JAERI-M 93-013 “Chemical Analysis of High Purity Graphite” using an inductively coupled plasma (ICP) emission spectrometric analyzer (model No. ICPE-9820, manufactured by Shimadzu Corporation).

Evaluation Results

The evaluation results of the electrode materials for a lithium-ion secondary battery and the lithium-ion secondary batteries of Examples 1 to 4 and Comparative Examples 1 and 2 are shown in Table 1. Meanwhile, the amount of carbon in Table 1 is the amount (parts by mass) of carbon forming the carbonaceous film with respect to 100 parts by mass of the cathode active material.

TABLE 1

| | | | | | | | Discharge | Capacity | Total volume of micropores that are |
|---|---|---|---|---|---|---|---|---|---|
| | | BET | | | | | capacity | retention | observed in the region in which |
| | | specific | Amount of | Discharge | Capacity | | (C1; | (C500/C1; | micropore diameters are 0.8 nm or |
| | | surface | carbon | capacity | retention | Fe + Mn on | containing | containing | less in carbon coating (per grem of |
| | Cathode | area | [parts by | (C1) | (C500/C1) | anode | VC) | VC) | mass of carbonaceous film) |
| | material | [m²/g] | mass] | [mAh/g] | [%] | [ppm] | [%] | [%] | [cm³/g] |
| Example 1 | A1-400 | 14.7 | 1.4 | 127 | 88 | 185 | 127 | 93 | 0.200 |
| | A1-500 | 14.5 | 1.4 | 129 | 88 | 318 | 128 | 93 | 0.277 |
| | A1-550 | 14.4 | 1.3 | 129 | 89 | 358 | 128 | 94 | 0.298 |
| | A1-600 | 13.9 | 1.2 | 130 | 88 | 430 | 130 | 93 | 0.301 |
| | A1-650 | 13.3 | 1.2 | 132 | 88 | 508 | 132 | 93 | 0.313 |
| Example 2 | A2 | 14.2 | 1.3 | 133 | 88 | 320 | 133 | 92 | 0.289 |
| Example 3 | A3 | 14.7 | 1.4 | 128 | 89 | 166 | 129 | 94 | 0.222 |
| Example 4 | A4 | 14.8 | 1.5 | 127 | 84 | 225 | 125 | 91 | 0.303 |
| Comparative | B1-350 | 15.0 | 1.5 | 100 | 66 | 159 | 96 | 86 | 0.118 |
| Example 1 | B1-725 | 12.0 | 1.2 | 133 | 69 | 1096 | 130 | 80 | 0.361 |
| | B1-775 | 11.0 | 1.1 | 133 | 68 | 1450 | 124 | 77 | 0.371 |
| | B1-800 | 10.2 | 1.0 | 133 | 59 | 1552 | 119 | 68 | 0.395 |
| Comparative | B2 | 10.9 | 1.0 | 111 | 65 | 2010 | 104 | 66 | 0.406 |
| Example 2 | | | | | | | | | |

The results in Table 1 show that the lithium-ion secondary batteries of Examples 1 to 4 had high capacities in high charge and discharge rates. In addition, it was found that the amounts of the metal ions (Fe and Mn) precipitated from the cathodes were small and the capacity retention after 500 cycles of the test was as high as 84% or more. What has been described was the same in a case in which vinylene carbonate (VC) which is a well-known additive that generates stable SEI films was not added to the electrolyte solution and in a case in which vinylene carbonate (VC) was added to the electrolyte solution. The reasons for obtaining the above-described results are not clear, but it is considered that the total volume of the micropores that were observed in the region in which micropore diameters were 0.8 nm or less in the carbonaceous film was set to 0.15 cm³ or more and 0.35 cm³ or less per mass (g) of the carbonaceous film, and thus structures that suppress the elution of the metal ions while maintaining sufficient electron conductivity and sufficient diffusivity of lithium ions could be obtained.

On the other hand, it was found that the lithium-ion secondary batteries of Comparative Examples 1 and 2 had insufficient high-rate characteristics or the amounts of the metal ions (Fe and Mn) precipitated from the cathodes were great and the capacity retention after 500 cycles of the test was as low as 69% or less. In Comparative Examples 1 and 2, it is considered that the total volume of the micropores that were observed in the region in which micropore diameters were 0.8 nm or less in the carbonaceous film was set to less than 0.15 cm³ per mass of the carbonaceous film, and thus the high-rate characteristics degraded. On the other hand, the total volume of the micropores that were observed in the region in which micropore diameters were 0.8 nm or less in the carbonaceous film was set to more than 0.35 cm³ per mass of the carbonaceous film, and thus the significant increase in the elution amount of the transition metal ions is considered to be the reason for an increase in the amount of the metal ions (Fe and Mn) precipitated.

Lithium-ion secondary batteries for which the cathode material for a lithium-ion secondary battery of the present invention is used have an excellent energy density, input and output characteristics, and durability and are thus capable of significantly contributing to the advancement of the reliability of lithium-ion secondary batteries including mobile body applications.

1. A cathode material for a lithium-ion secondary battery comprising:
active material secondary particles formed by aggregating central particles including primary particles of a cathode active material represented by General Formula LiₐAₓBO₄, wherein A represents at least one element selected from the group consisting of Mn, Fe, Co, and Ni, B represents at least one element selected from the group consisting of P, Si, and S, 0≤a21 4, and 0<x<1.5, and a carbonaceous film, wherein at least a portion of surfaces of the primary particles are coated with the carbonaceous film, and the carbonaceous film is obtained by thermal decomposition of an organic compound,
wherein a total volume of micropores in the carbonaceous film observed in a range of 0.8 nm or less of the micropore diameters measured by a gas adsorption method is 0.15 cm³ or more and 0.35 cm³ or less per mass (g) of the carbonaceous film.

2. (canceled)

3. A cathode for a lithium-ion secondary battery, comprising:
an electrode current collector; and
a cathode mixture layer formed on the electrode current collector,
wherein the cathode mixture layer includes the cathode material for the lithium-ion secondary battery according to claim 1.

4. A lithium-ion secondary battery comprising:
the cathode for the lithium-ion secondary battery according to claim 3.

5. A method for manufacturing the cathode material for the lithium-ion secondary battery according to claim 1, comprising:
a step of preparing a slurry including the organic compound which serves as a carbon source and at least one of the cathode active material and a precursor which is turned into the cathode active material by heating; and
a step of thermally treating the slurry at 400° C. to 650° C. in a non-oxidative atmosphere.

6. The cathode material for the lithium-ion secondary battery according to claim 1,
wherein, in a charge and discharge cycle test at 60° C. of the lithium-ion secondary battery comprising a cathode including the active material secondary particles and an anode made of graphite, an amount of the element represented by A, which penetrates into or is precipitated on the anode after 500 cycles, is 600 ppm or less with respect to a mass of the active material secondary particles.
